(19) United States
(12) Patent Application Publication
(10) Pub. No.: US 2019/0170211 A1
(43) Pub. Date: Jun. 6, 2019

(54) DEVICE FOR DAMPING TORSIONAL OSCILLATIONS FOR A VEHICLE TRANSMISSION SYSTEM

(71) Applicant: VALEO EMBRAYAGES, Amiens Cedex 2 (FR)

(72) Inventors: Gabriel BOUCHE, Amiens (FR); Pascal DAST, Amiens (FR); Matthieu MALLEY, Amiens (FR)

(73) Assignee: VALEO EMBRAYAGES, Amiens Cedex 2 (FR)

(21) Appl. No.: 16/302,200

(22) PCT Filed: Apr. 26, 2017
(86) PCT No.: PCT/FR2017/050991

§ 371 Date: Nov. 16, 2018

(30) Foreign Application Priority Data
May 19, 2016 (FR) 1654454

(51) Int. Cl. F16F 15/14; F16F 15/30

(52) U.S. Cl. CPC F16F 15/145; F16F 15/30

(57) ABSTRACT

A pendulum device including a mounting, rotatably movable and capable of being rigidly connected to the component, and at least one pendulum body movable relative to the mounting, the movement of the pendulum body relative to the mounting being guided by at least one rolling member engaging with at least one first raceway rigidly connected to the mounting and at least one second raceway rigidly connected to the pendulum body, the pendulum body including first and second pendulum masses, and at least one member linking the first and second masses pairing the masses, the linking member being arranged in an opening of the mounting of which one portion of the contour defines the first raceway, characterised in that the linking member extends between a first plane and a second plane which are tangential to the linking member, the second raceway is defined by the contour of the linking member and extends from a third plane to a fourth plane which are secant to the linking member, and a first distance measured between the first plane and the second plane is 1.5 to 3.5 times greater than a second distance measured between the third plane and the fourth plane, the first plane, the second plane, the third plane and the fourth plane being parallel to one another.

The present invention relates to a component for a vehicle transmission system comprising a pendulum-type device.

The invention is applicable especially but not exclusively to so-called industrial vehicles, which are, for example, heavy goods vehicles, public transportation vehicles or agricultural vehicles.

The invention may also be applicable to so-called passenger vehicles.

In such an application, the pendulum-type device may be integrated into a clutch capable of selectively coupling the combustion engine to the gearbox, in order to filter the torsional oscillations due to rotational irregularities of the engine.

Such a pendulum-type device traditionally employs a support and one or more pendulum-type members capable of moving relative to this support, wherein the displacement of the pendulum-type members relative to the support is guided by rolling means, cooperating on the one hand with rolling tracks integral with the support and on the other hand with rolling tracks integral with the pendulum-type members. As an example, each pendulum-type member comprises two pendulum-type masses connected to one another by a connecting means, which also defines the rolling track integral with the support.

It is known how to make the support of the device for damping torsional oscillations integral with a primary flywheel, integral with the crankshaft of the combustion engine of the vehicle. In such a functional emplacement, the device for damping torsional oscillations is disposed in the propulsion train directly downstream from the combustion engine, i.e. without damping means interposed between the crankshaft and the support of the pendulum-type device. The pendulum-type members are then in a hostile environment, in which they are subjected to torsional oscillations of very high intensity. Nevertheless, such a functional emplacement of the pendulum-type device may prove desirable in order to achieve a first filtering of these torsional oscillations.

In an application of industrial vehicle type, the stresses to which the pendulum-type masses are subjected are extremely large, and the connecting means must be adapted to ensure that these pendulum-type masses do not come apart during functioning. When the pendulum-type device is integral with the primary flywheel, it is customary to dispose it on the side belonging to the crankshaft and the combustion engine. This positioning makes it more easily accessible for maintenance, but it is also a positioning having risk for the crankshaft and for the combustion engine, which are disposed directly facing the device. In particular, the combustion engine is vulnerable if masses rotating at full speed come apart.

Thus a need exists to permit the use of a pendulum-type device that is capable of functioning when the torsional oscillations that it experiences have not been previously filtered and that is adapted to the stresses associated with vehicles of industrial type.

The object of the invention is to meet this need, and it achieves this, according to one of its aspects, by means of a pendulum-type device capable of being integrated into a vehicle transmission system component, especially for an industrial vehicle, comprising:
a support that is mobile in rotation and is capable of being made integral with the component, and
at least one pendulum-type member that is mobile relative to the support, wherein the displacement of the pendulum-type member relative to the support is guided by at least one rolling means cooperating with at least one first rolling track integral with the support and with at least one second rolling track integral with the pendulum-type member, wherein the pendulum-type member comprises:
a first and a second pendulum-type mass spaced axially relative to one another and mobile relative to the support, wherein the first pendulum-type mass is disposed on a first side of the support and the second pendulum-type mass is disposed on a second side of the support, and
at least one means for connecting the first and the second mass and pairing the said masses, wherein the connecting means is disposed in a window of the support, one part of the contour of which defines the first rolling track, characterized in that
the connecting means extends between a first plane (P1) and a second plane (P2), which are tangents to the connecting means,
the second rolling track (25) is defined by the contour of the connecting means (20) and extends from a third plane (P3) toward a fourth plane (P4), which are secants to the connecting means,
a first distance D5 measured between the first plane and the second plane is 1.5 to 3.5 times greater than a second distance D6 measured between the third plane and the fourth plane, wherein the first plane, the second plane, the third plane and the fourth plane are parallel to one another.

According to one aspect of the invention, the distance between the first plane and the third plane on one side and the distance between the second plane and the fourth plane on another side are equidistant.

According to another aspect of the invention, the part of the connecting means dedicated to rolling of the pendulum-type member is localized and minimized in such a way that the part available for fixation of the pendulum-type masses is optimized to improve the stability of the pendulum-type masses among one another. Such a connecting means is therefore particularly well adapted to respond to the constraints associated with industrial vehicles.

Within the meaning of the present Application:
“axially” means “parallel to the axis of rotation of the support”,
“radially” means “along an axis in a plane orthogonal to the axis of rotation of the support and intersecting that axis of rotation of the support”,
“angularly” or “circumferentially” means “around the axis of rotation of the support”,
“integral with” means “rigidly coupled with”,
the rest position of the device is that in which its pendulum-type members are subjected to a centrifugal force but not to torsional oscillations due to rotational irregularities of the combustion engine,
the contour of the window is the surface of the support defining the window.

According to one aspect of the invention, the connecting means cooperates with one single rolling means. Thus the rolling means defines only a single rolling track.

According to one aspect of the invention, the means of symmetric, especially at least functionally relative to a plane that includes the axis of rotation. Thus it may be mounted in a direction or in the order by the operator in such a way that there is no risk of inversion of the direction of mounting in a window, nor of risk of inversion of the connecting means when the device comprises several pendulum-type members and/or two connecting means per pendulum-type member.

According to one aspect of the invention, the window may be symmetric, which also simplifies the fabrication of the mounting, especially when there are several windows in the support.

According to one aspect of the invention, the ratio between the angular dimension of the connecting means and the dimension of the window may range between 0.6 and 0.9, preferably between 0.7 and 0.8.

According to one aspect of the invention, the second connecting track may extend over an angular dimension smaller than 65%, especially smaller than 50% of the angular dimension of the connecting means.

Within the meaning of the present Application, “the angular dimension” of a part is the maximum angle defined by two lines starting from an axis parallel to the axis of rotation of the support (for example, an axis belonging to a plane of symmetry of this piece) and intersecting the said part.

According to another aspect of the invention, the connecting means may be provided with at least one system for connection of the pendulum-type masses that extends radially at least in part in the region of the second rolling track.

Such a system makes it possible to dispense with the need to dispose the assembly function radially underneath the rolling track and therefore to benefit from a radially compact connecting means. The part of the rolling means, especially that radially underneath the second rolling track, left free from the assembly function, may be used for other functions associated with the connecting means, such as the function of abutting damping.

By the fact of its radial compactness, such a connecting means is therefore capable of being displaced radially to a limited extent. Consequently, the window and the support in which this is fitted may be configured to reduce the radial space requirement of the device.

Within the meaning of the Application, two parts “are at least partly at the same level radially” when, in a plane perpendicular to the axis of rotation, a circle centered on the axis of rotation exists that intersects these two parts.

According to one aspect of the invention, the connecting system may comprise an assembly element received in an opening made in one circumferential end of the connecting means.

The opening may be positioned at a predefined distance D7 relative to the second track. In fact, the opening has a peripheral rim. The distance D7 is measured along a line passing through a tangent to the peripheral rim and situated closest to the second rolling track and through the second rolling track. This distance D7 is preferably greater than or equal to a thickness of the connecting means. Thus, with such an arrangement of the opening relative to the second rolling track, potential risks of deformation of the second rolling track in the course of the process of fixation of the connecting means to the two pendulum-type masses are limited, even suppressed. The thickness of the connecting means is measured axially.

The opening may be offset circumferentially from the second rolling track and may extend at least in part radially in the region of this rolling track.

As an example, the assembly means is a rivet.

The opening may be circular. The diameter of this opening may range between 6 and 10 mm.

According to one aspect of the invention, the circumferential end may have the form of a substantially rounded lobe. The circumferential end may extend circumferentially from the second rolling track. The meeting point of the circumferential end and the second rolling track may define a discontinuity of the trajectory of the contour, thus forming one of the two circumferential ends of the second rolling track. The circumferential end may extend radially outward relative to the second rolling track. The circumferential end may be connected to the rest of the connecting means via a thinner zone of the said means.

The circumferential end may come into contact with the contour of the window upon completion of a maximum displacement in the circumferential direction of the pendulum-type member from the rest position. Such a contact makes it possible to limit the displacement of the pendulum-type member in the circumferential direction.

The circumferential end and the contour of the window may be shaped in such a way that the contact is established along a surface upon completion of the maximum displacement. This makes it possible to distribute the forces associated with this contact and to minimize the wear of the two parts (support and connecting means).

According to one aspect of the invention, the opening may be made by cutting, especially by stamping. This makes it possible to dispose a rolling means, which may be obtained according to a traditional, well mastered and economic method of execution.

According to one aspect of the invention, the circumferential end may be configured in such a way that the opening may be made by cutting, especially by stamping. The dimensions of the connecting means may be chosen in order that the connecting means has good mechanical stability after completion of the opening by cutting, especially by stamping. According to one aspect of the invention, the opening may be at a minimum distance, greater than half of the axial dimension of the connecting means, from the contour of the connecting means. The axial dimension of the connecting means may range between 5 and 9 mm, especially between 6.5 and 7.5 mm, and in particular may be substantially equal to 6.8 mm. Such a quantity of material ensures that the cutting impacts the mechanical stability of the connecting means only slightly.

Each of the pendulum masses may also be configured in such a way that the opening receiving the assembly means may be made by cutting, especially by stamping. In particular, openings receiving the assembly means, for example rivets, and made in the pendulum-type masses, may be at a minimum distance, greater than half of the axial dimension of the pendulum-type masses, from the contour of the pendulum-type masses. The axial dimension of the pendulum-type masses may range between 6 and 10 mm, especially be substantially equal to 8 mm.

According to one aspect of the invention, the pendulum-type device may comprise at least one abutting damping means interposed radially between the support and the connecting means. This damping means makes it possible to reduce the shocks between the pendulum type member and the support upon completion of an intermediate displacement, in circumferential direction, of the pendulum-type member from the rest position and/or in case of radial drop of the pendulum-type member, for example during stoppage of the combustion engine of the vehicle.

The abutting damping means may have elastic properties permitting damping of shocks associated with the occurrence of contact between the pendulum-type member and the support. As an example, the damping means is made of elastomer or rubber.

According to one aspect of the invention, the damping means may be integral with the connecting means. The damping means may have a substantially cubic shape. The damping means may be received in a recess made in the connecting means. The damping means may be force-fitted into the recess. The damping means may be held radially by interlocking shape in the recess. The recess may make it possible to define the thinner zone of the connecting means via which the circumferential end is connected to the rest of the said means.

The damping means may be disposed on the side of the circumferential end in which the opening receiving the assembly element is made.

Upon completion of an intermediate displacement of the pendulum-type member from its rest position, the abutting damping means may come into contact with the connecting means and the support to damp the shocks then, upon completion of a maximum displacement, the connecting means may come directly into contact with the support in order to stop the displacement of the pendulum-type member.

Between the intermediate displacement and the maximum displacement of the pendulum-type member, the damping means is progressively compressed. Between the intermediate displacement and the maximum displacement of the pendulum-type member, the damping means is progressively compressed. The pendulum-type member, especially its circumferential end, may be configured in such a way that the maximum crushing of the damping means does not go beyond 25% of its maximum dimension.

The damping means defines two lateral faces facing pendulum-type masses; each of these lateral faces may be provided with an axially projecting stud. These studs may face one another axially. The axial dimension of the means in the region of the studs is larger than the axial spacing between the pendulum-type masses, in such a way that the studs are permanently in contact with these said masses. These contacts make it possible to immobilize the damping means in the recess by friction. Since these studs are localized on the axial surfaces, they permit a slight axial movement of the abutting damping means.

Each stud may be of substantially rounded shape. The axial dimension of each stud may range between 0.2 and 0.6 mm, and in particular may be equal to 0.4 mm.

According to another aspect of the invention, the connecting means may be provided with two openings for receiving the assembly means circumferentially framing the second rolling track. Each opening may be made in the form of a lobe in one circumferential end of the connecting means.

Each opening may extend radially, at least in part, in the region of the second rolling track.

The device may be provided with two abutting damping means, wherein each is associated exclusively with one circumferential displacement of the pendulum-type member, either in the clockwise or in the counterclockwise direction. As a variant, a single abutting damping means may be provided, in which case it will act for a displacement of the pendulum-type member in the circumferential direction independently of whether this is clockwise or counterclockwise.

Between the two recesses in which the abutting damping means are received, the connecting means may have an anchor shape, permitting radial retention of the said means.

The recesses may be disposed circumferentially between the openings of the assembly means and radially inward relative to the second rolling track.

In all of the foregoing, the support may be one of a kind and may be made in one piece. As an example, the support is a hollow metal sheet. The support may extend exclusively between a substantially circular radially interior rim and a substantially circular radially exterior rim, wherein the functions for guidance of the displacement of the pendulum-type members and for fixation on the component are then concentrated in the space defined between the aforesaid rims of the support.

The rolling means may cooperate with exclusively one first rolling track and exclusively with one second rolling track. The rolling means may cooperate with the rolling tracks exclusively via its exterior surface. Thus one and the same portion of this exterior surface may cooperate alternatively with the two first and second rolling tracks when the rolling means is being displaced.

The window may be a hollow space with closed and continuous contour made in the support. The window defines an empty space in the interior of the support. Exclusively one connecting means, one rolling means and possibly one or more abutting damping means may be disposed in the window.

The first rolling track may be defined by a part, oriented radially toward the interior, of the contour of the window. The second rolling track may be defined by a contour part of the connecting means that is oriented radially toward the exterior.

The rolling means may be subjected to compression exclusively between the first and second rolling tracks mentioned hereinabove. The first and second rolling tracks may be in radially facing relationship, at least in part. In other words, planes perpendicular to the axis of rotation exist in which both of these rolling tracks extend.

As an example, the rolling means is a roller of circular section in a plane perpendicular to the axis of rotation of the support. The axial ends of the rolling means may be free of terminal annular shoulder. As an example, the rolling means is made of steel. The rolling means may be hollow or solid. The circular section of the rolling means may range between 15 and 25 mm, and in particular may be equal to 19 mm.

In all of the foregoing, the pendulum-type member may be configured to be tuned to an order value chosen such that the ratio between this order value and the order of excitation of the combustion engine is greater than 1.1.

Tuning to such an order value of the pendulum-type member permits it to withstand these torsional oscillations without having to be over-dimensioned. This may be necessary in particular when the pendulum-type device is integrated in a component upstream from any filtration, such as, for example, the primary flywheel connected to the crankshaft. In such a configuration, the pendulum-type device experiences the engine torque without any filtering thereof beforehand.

The pendulum-type member may be tuned to a higher order value, especially slightly higher than the excitation order of the combustion engine.

In all of the foregoing, the tuning of the pendulum-type member to the order value mentioned hereinabove may be achieved by acting on all or part of the following parameters:
shape of the first rolling track,
shape of the second rolling track,
inertia of the pendulum-type member,
distance, when the device is at rest, between the center of gravity of the pendulum-type member and the axis of rotation of the support,
distance, when the device is at rest, between the center of gravity of the pendulum-type member and the point of attachment of the pendulum-type member on the support, and
shape of the rolling means.

In particular, the pendulum-type member may be configured to be tuned to an order value chosen such that the ratio between this order value and the order of excitation of the combustion engine of the vehicle is greater than 1.1 and less than the value of this ratio corresponding to the order value from which the graph representing, as a function of the order value of the pendulum-type member, the ratio between the amplitude of the torsional oscillations at the output of the damping device and the amplitude of these oscillations at the input of the said device, i.e. the filtering performance of this device, reaches a plateau.

The graph mentioned above then becomes substantially horizontal beyond this range of order values. Such a range of order values makes it possible to dispose a pendulum-type device capable of withstanding the torsional oscillations arriving directly from the combustion engine, because the pendulum-type member exhibits a deflection from its rest position such that its abutting against the support does not take place in excessive manner. Furthermore, this range of order values makes it possible to ensure satisfactory filtering of these torsional oscillations. Thus the fact of detuning the pendulum-type member from the order of excitation of the combustion engine permits it to be used directly downstream from the combustion engine of the vehicle, even though this leads to s slight degradation of the filtering performances. Thus the foregoing range of values ensures a better compromise.

In all of the foregoing, the pendulum-type member may also be configured to be tuned to an order value greater than or equal to 2, especially greater than or equal to 3, wherein it is in particular greater than or equal to 3.3, less than or equal to 4, especially less than or equal to 3.5.

This order value implies small deflection, such that the windows associated with the connecting means may be of reduced dimension. The support is therefore rigid and adapted to positioning on the primary flywheel or primary flywheel, especially of an industrial vehicle.

In the case of a six-cylinder combustion engine, the pendulum-type member may be configured to be tuned to an order value greater than or equal to 3.3, less than or equal to 3.5.

In all of the foregoing, the shape of the rolling tracks may be such that the pendulum-type members are displaced exclusively relative to the support by translation around an imaginary axis parallel to the axis of rotation of the support.

As a variant, the shape of the rolling tracks may be such that the pendulum-type members are displaced relative to the support both:
by translation around an imaginary axis parallel to the axis of rotation of the support, and
also by rotation around the center of gravity of the said pendulum-type member, wherein such a movement is also known as “combined movement” and is disclosed, for example, in German Application DE 10 2011 086 532.

According to one aspect of the invention, the pendulum-type member may comprise two connecting means such as described in the foregoing. Each connecting means may be received in a window specific to it, wherein two separate windows are then associated with one and the same pendulum-type member.

As an example, the device comprises several pendulum-type members, for example a number between two and eight, especially three or five pendulum-type members. All of these pendulum-type members may follow one another circumferentially. The device may therefore comprise a plurality of planes that are perpendicular to the axis of rotation and in each of which all of the pendulum-type members are disposed.

Separate windows of the support may then be associated with one and the same pendulum-type member, wherein each window receives one of the connecting means and the associated rolling means.

In all of the foregoing, an interposed part, also known as “runner”, may be provided to be interposed axially between the support and the pendulum-type masses, in such a way as to avoid the axial shocks between these masses.

According to one aspect of the invention, the pendulum-type device may be configured in such a way that the angularly neighboring pendulum-type members never come into contact with one another.

The distance between two adjacent windows may be chosen as a function of the shape of these said windows and of the shape of the pendulum-type masses, so that the angularly neighboring pendulum-type members never come into contact with one another.

The distance between two adjacent windows, each associated with separate pendulum-type members may range between 30 and 45 mm and in particular may be equal to 36 mm.

The distance between two windows that are adjacent and associated with one and the same pendulum-type member may range between 25 and 40 mm and in particular may be equal to 29 mm.

As the case may be, the lateral faces of each pendulum-type mass may have a shape that guarantees the existence of this zone that has been left free. As an example, clearances are made on these lateral faces.

According to another of its aspects, the invention also has as an object a primary flywheel capable of being made integral with a crankshaft of a combustion engine, wherein the flywheel integrates a pendulum-type device such as described hereinabove.

According to this aspect of the invention, the device for damping torsional oscillations is capable of being fixed on the primary of the transmission system, wherein “primary” means “integral with the crankshaft of the combustion engine”.

The flywheel may be rigid, i.e. without energy accumulation means such as springs.

According to one aspect of the invention, the flywheel may define a cavity in which the pendulum-type device is received. In particular, the pendulum-type device may extend entirely into this cavity, radially and/or axially. The addition of such a pendulum-type device and the shape of the cavity make it possible to keep the inertia and the mass of a primary flywheel having no pendulum-type device substantially unchanged, so that the resistance to stresses is substantially identical. In particular, the variations of the mass and inertia of the flywheel will remain smaller than 5%, especially smaller than 2%, preferably smaller than 1%.

The device may extend over a localized and reduced portion of the primary flywheel. The ratio between the radial dimension of the pendulum-type device and the radial dimension D2 of primary flywheel 1 may range between 0.25 and 0.4, and in particular may be around 0.33.

The support and the flywheel may be mounted without possible relative movement between them. This makes it possible to optimize, in particular to minimize the shape of the cavity, in particular its radial dimension. The radial space between the pendulum-type device and the flywheel makes it exclusively possible to avoid the assembly problems.

The cavity may be opened axially in the direction of the crankshaft and of the combustion engine, in such a way that the pendulum-type device is easily accessible, especially in the case of maintenance.

The support may be made integral, radially inwardly, relative to the pendulum-type masses, on a shoulder of the primary flywheel. The radially inward rim of the support may comprise radially extending tabs for the passage, for example, of screws or rivets to maintain the support integrally. These tabs may have rounded shape and be distributed circumferentially around the axis of rotation. Axial seats may be provided in the flywheel to receive the tabs, so that they can be held in position circumferentially. These seats also facilitate the guidance of the pendulum-type device while it is being put into place.

The cavity may comprise:
a first zone bounded by the shoulder on which the support is fixed, and
a second zone radially outward relative to the first zone, in which the pendulum-type member or members are received,
   wherein the second zone is axially deeper that the first zone, such that the pendulum-type members may be seated entirely in the cavity.

The invention will be more understandable by reading the description hereinafter of a non-limitative exemplary embodiment thereof and by examining the attached drawing, wherein:

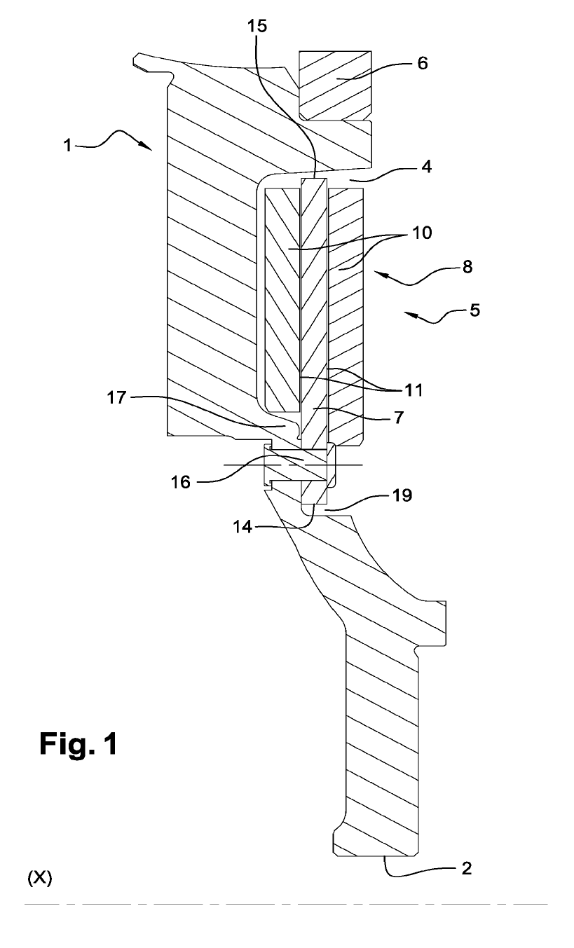

FIG. 1 is a view in section of a primary flywheel according to the invention in a plane that includes the axis of rotation,

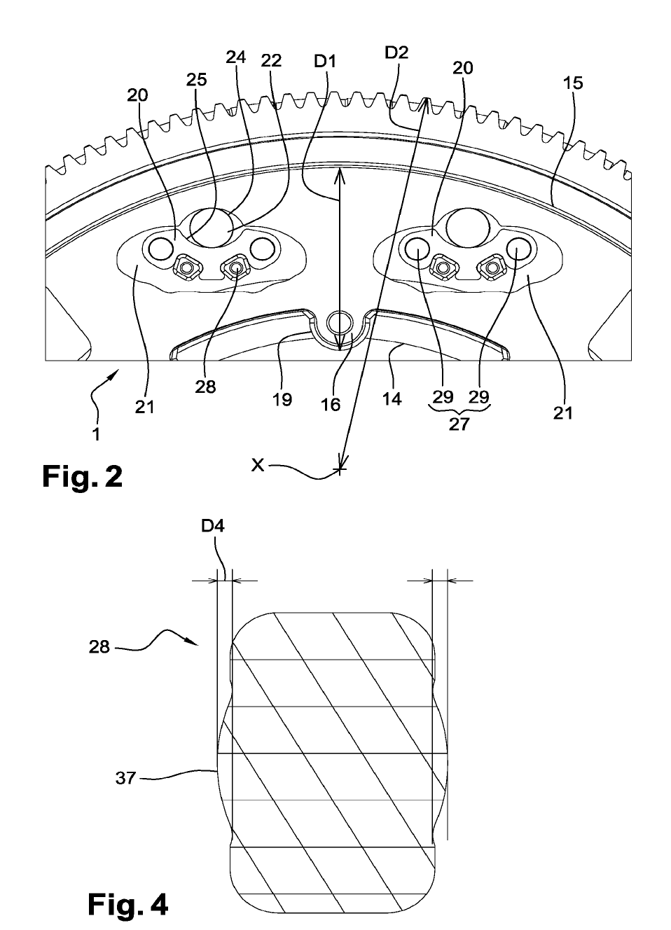

FIG. 2 is a front view of part of the primary inertial flywheel of FIG. 1,

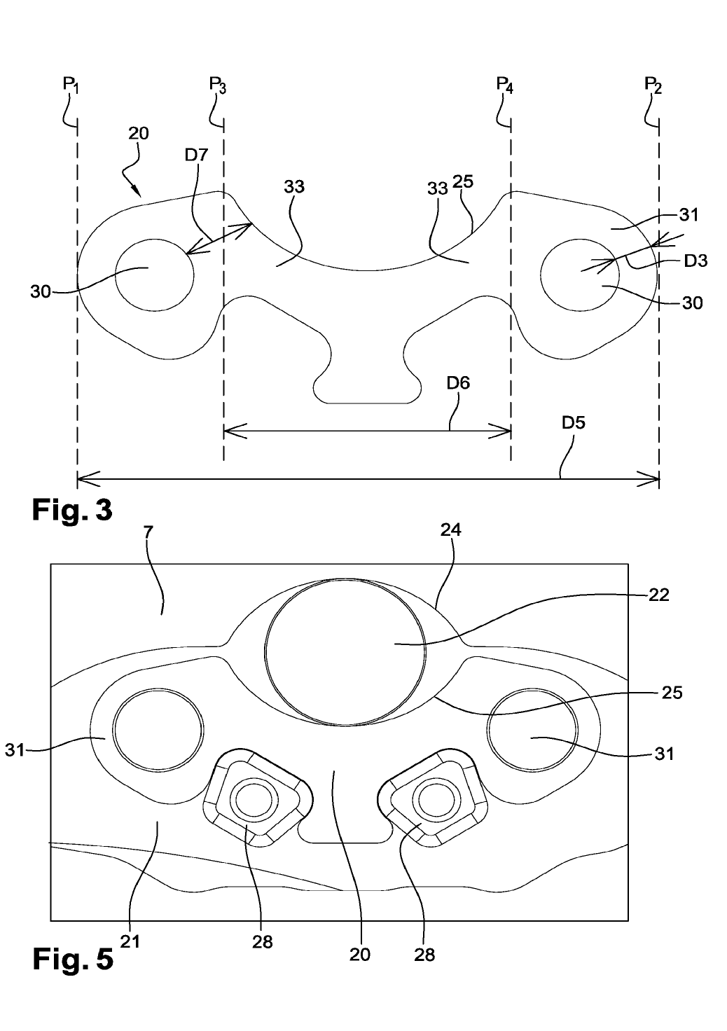

FIG. 3 schematically represents a connecting means of a pendulum-type device according to the invention,

FIG. 4 represents an abutting damping means of a pendulum-type device according to the invention, and

FIG. 5 is a detail of FIG. 2.

FIG. 1 represents, for an industrial vehicle, such as a heavy goods vehicle, a primary flywheel 1, which is mobile in rotation around an axis of rotation X and is capable of being made integral with a crankshaft, not represented here, of a combustion engine. Only holes 2 for the passage of screws used to hold the two parts in integral manner are visible in FIG. 1. These holes 2 are distributed circumferentially around axis X.

In the example under consideration, flywheel 1 is rigid and it defines a cavity 4, in which a pendulum-type device 5 is received. This cavity 4 is open axially in the direction of the crankshaft.

In the example considered in FIG. 1, pendulum-type device 5 extends entirely into this cavity 4, axially and radially.

In the example under consideration, flywheel 1 is provided with a starting ring 6 extending over an axial height equal to that of cavity 4.

In the example under consideration, the pendulum-type device comprises a support 7, which is mobile in rotation around axis X, and a plurality of pendulum-type members 8 that are mobile relative to the support. The number of pendulum-type members may range here between two and eight, especially five pendulum-type members 8, wherein all of these pendulum-type members 8 follow one another circumferentially.

Each pendulum-type member 8 comprises a first and a second pendulum-type mass 10 spaced axially relative to one another and mobile relative to support 7, wherein the first pendulum-type mass is disposed on a first side 11 of the support and the second pendulum-type mass is disposed on a second side 11 of the support.

In the example under consideration, support 7 is one of a kind and is made in one piece, for example as a hollow metal sheet. Support 7 extends exclusively between a substantially circular radially interior rim 14 and a substantially circular radially exterior rim 15. In the example under consideration, the radially inward rim 14 comprises radially extending tabs 16 for the passage, for example, of screws or rivets to hold support 7 in integral manner, radially inward relative to pendulum-type masses 10, on a shoulder 17 of the primary flywheel. These tabs 16, which are visible in FIG. 2, may have rounded shape and be distributed circumferentially around axis X. Axial seats 19 are provided in flywheel 1 to receive these tabs 16.

In the example under consideration, the cavity therefore comprises:
a first zone bounded by shoulder 17, on which support 7 is fixed, and
a second zone radially outward relative to the first zone, in which the pendulum-type members 8 are received,

wherein the second zone is axially deeper that the first zone, such that the pendulum-type members 8 are seated entirely in cavity 4.

FIG. 2, which is a front view of the flywheel of FIG. 1, makes it possible to describe pendulum-type device 5 in detail.

In the example under consideration, the ratio between radial dimension D1 of the pendulum-type device, more precisely between the radial dimension of support 7 (wherein the pendulum-type members do not extend radially past the support), and radial dimension D2 of primary flywheel 1 ranges between 0.25 and 0.4.

In the example under consideration, each pendulum-type member 8 comprises two connecting means 20, each pairing first and second pendulum-type masses 10, one of which is represented transparently in FIG. 2. Each connecting means 20 is received in a window 21, which is specific to it, wherein two separate windows 21 are then associated with one and the same pendulum-type member 8. Each window 21 may be a hollow space with closed and continuous contour, made in support 7, and each window 21 defines an empty space in the interior of the support.

In the example under consideration, the pendulum-type device may be configured in such a way that the angularly neighboring pendulum-type members 8 never come into contact with one another. The distance between two adjacent windows 21 may be chosen as a function of the shape of these said windows 21 and of the shape of pendulum-type masses 10, so that the angularly neighboring pendulum-type members 8 never come into contact with one another.

For example, the distance between two adjacent windows 21, each associated with separate pendulum-type members 8, may range between 30 and 45 mm and in particular may be equal to 36 mm.

For example, the distance between two windows 21 that are adjacent and associated with one and the same pendulum-type member 8 may range between 25 and 40 mm and in particular may be equal to 29 mm.

Although this is not represented, the lateral faces of each pendulum-type mass may have a shape that guarantees the existence of this zone that has been left free. As an example, clearances are made on these lateral faces.

In the example under consideration, the displacement of each angular pendulum-type member 8 relative to support 7 is guided by two rolling means 22, each associated with a connecting means 20 cooperating exclusively with a first rolling track 24 integral with support 7 and exclusively with a second rolling track 25 integral with pendulum-type member 8.

Here, each rolling means 22 is a roller of circular section in the plane of the figure. In particular, the axial ends of the rolling means may be free of terminal annular shoulder. As an example, rolling means 22 are made of steel and they may be hollow or solid. The circular section of the rolling means may range between 15 and 25 mm, and in particular may be equal to 19 mm.

In the example under consideration, each first rolling track 24 is defined by a part of the contour of window 21 oriented radially toward the interior, and each second rolling track 25 is defined by a contour part of connecting means 20 that is oriented radially toward the exterior.

These first and second rolling tracks 24, 25 are radially facing, and each rolling means 22 cooperates with these rolling means 24, 25 exclusively via its exterior surface, in such a way that each rolling means 22 is loaded exclusively in compression between the above-mentioned rolling tracks when primary flywheel 1 is turning around axis X.

In the example under consideration, each connecting means is also provided with a system 27 for connection of the pendulum-type masses. The pendulum-type device is also provided with abutting damping means 28, wherein two damping means 28 are integral with each connecting means 20. Exclusively one connecting means 20, one rolling means 22 and two abutting damping means 28 are disposed in each window 21. These elements will be described in detail with reference to the following figures.

FIG. 3 schematically represents a connecting means of a pendulum-type device according to the invention. In the example under consideration, second rolling track 25 is localized on the part of the contour of the connecting means that is oriented radially toward the exterior. The connecting means extends between a first plane P1 and a second plane P2, which are tangents to the connecting means.

Second rolling track 25 is defined by the contour of connecting means 20 and extends from a third plane P3 to a fourth plane P4, which are secants to the connecting means. A first distance D5 measured between the first plane and the second plane is 1.5 to 3.5 times greater than second distance D6 measured between the third plane and the fourth plane, wherein the first plane, the second plane, the third plane and the fourth plane are parallel to one another.

In one example, the distance between first plane P1 and second plane P2 is equal to 60 mm, and the distance between third plane P3 and fourth plane P4 is equal to 27.4 mm.

The connecting means is symmetric according to a plane perpendicular to the plane of the figure; the angular dimension is measured from an axis X′ parallel to axis X, belonging to this plane of symmetry.

In the example under consideration, system 27 for connecting the pendulum-type masses comprises two assembly elements 29, especially rivets, visible in FIGS. 2 and 4, each received in an opening 30 made in one of the two circumferential ends 31 of the connecting means, wherein these ends have no second rolling track 25 localized circumferentially at the center of connecting means 22.

The openings 30 circumferentially frame second rolling track 25 and in part are radially at the level of the second rolling track if connecting system 27 extends at least radially to the level of the second rolling track.

In the example under consideration, openings 31 are circular and their diameter may range between 6 and 10 mm.

In the example under consideration, each circumferential end 31 has the form of a substantially rounded lobe. Each circumferential end 31 extends circumferentially from second rolling track 25. The meeting point of each circumferential end 31 and second rolling track 25 defines a discontinuity of the trajectory of the contour of connecting means 20, thus forming one circumferential end of second rolling track 25. Each circumferential end 31 extends radially outward relative to second rolling track 25. Each circumferential end 31 is connected to the rest of the connecting means via thinner zone 33 of the said means.

In the example under consideration, the opening may be made by cutting, especially by stamping. Each circumferential end 31 is configured in such a way that opening 30 may be made by cutting, especially by stamping. Each opening 30 is at a minimum distance D3 greater than half of the axial dimension of connecting means 20, which dimension may range between 6.5 and 7.5 mm, and in particular may be equal to 6.8 mm.

Each of the pendulum masses 10 may also be configured in such a way that the opening receiving the assembly means may be made by cutting, especially by stamping. Thus openings receiving the rivets made in the pendulum-type masses, may be at a minimum distance, greater than half of the axial dimension of the pendulum-type masses 10, from the contour of the pendulum-type masses. This dimension may range between 6 and 10 mm, and in particular may be equal to 8 mm.

In the example under consideration, the two abutting damping means 28, not represented in FIG. 3, are interposed radially between support 7 and connecting means 20. Each damping means 28 is received in a recess 35 made in connecting means 22.

Damping means 28 is held radially by interlocking shape in recess 35. Recess 35 defines thinner zone 33 of the connecting means via which circumferential end 31 is connected to the rest of the said means 20.

Between the two recesses 35 associated with each of the two damping means 28, the connecting means has an anchor shape, permitting radial retention of the said damping means. The two recesses 35 are disposed circumferentially between the openings of assembly means 31 and radially inside relative to second rolling track 25.

An example of damping means 28 is presented in FIG. 4. In the example under consideration, damping means 28 may have elastic properties permitting damping of shocks associated with the occurrence of contact between the pendulum-type member 8 and support 7. As an example, damping means 28 is made of elastomer or rubber.

In the example under consideration, damping means 28 has a substantially cubic shape and two lateral faces facing the pendulum-type masses. These lateral faces are each provided with an axially projecting stud 37, and these studs 37 are facing one another. The axial dimension of the means in the region of the studs is larger than the axial spacing between the pendulum-type masses, in such a way that the studs are permanently in contact with these said masses. Each stud 37 is of substantially rounded shape. Axial dimension D4 of each stud ranges between 0.2 and 0.6 mm, and in particular is equal to 0.4 mm.

To filter the torsional oscillations, each pendulum-type member 8 is displaced relative to support 7 by being guided by the rolling means cooperating with the rolling tracks. In the case in which the primary flywheel is made integral with the crankshaft of a six-cylinder combustion engine, the pendulum-type member may be configured to be tuned to an order value greater than or equal to 3.3, less than or equal to 3.5.

The tuning of the pendulum-type member to the order value mentioned hereinabove may be achieved by acting on all or part of the following parameters:
shape of the first rolling track 24,
shape of the second rolling track 25,
inertia of the pendulum-type members 8,
distance, when device 5 is at rest, between the center of gravity of pendulum-type members 8 and axis of rotation X,
distance, when the device is at rest, between the center of gravity of pendulum-type members 8 and the point of attachment of pendulum-type members 8 on support 7, and
shape of the rolling means 22.

In the configured example, for example in the case of too large vibrational oscillations and upon completion of an intermediate displacement of pendulum-type member 8 in the circumferential direction, for example in the clockwise direction, for example in the counterclockwise direction, from its rest position, which position is represented in FIG. 5, one of the two damping means 28 comes into contact with support 7 in order to damp the shocks. Starting from this intermediate displacement and up to the maximum displacement of pendulum-type member 8, the damping means 28 is progressively compressed. Upon completion of the maximum displacement, the connecting means, via one of its circumferential ends 31, comes directly into contact with the support in order to stop the displacement of pendulum-type member 8 and the compression of abutting means 28. Circumferential end 31 of the contour of window 22 may be shaped in such a way that the contact is established along a surface upon completion of the maximum displacement.

In the example under consideration, each damping means is associated exclusively with clockwise or counterclockwise direction of circumferential displacement of pendulum-type member 8.

The invention is not limited to the examples that have just been described.

1. A pendulum-type device capable of being integrated into a vehicle transmission system component, especially for an industrial vehicle, comprising:
a support, that is mobile in rotation and is capable of being made integral with the component, and
at least one pendulum-type member that is mobile relative to the support, wherein the displacement of the pendulum-type member relative to the support is guided by at least one rolling means cooperating with at least one first rolling track integral with the support and with at least one second rolling track integral with the pendulum-type member, wherein the pendulum-type member comprises:
a first and a second pendulum-type mass spaced axially relative to one another and mobile relative to the support, wherein the first pendulum-type mass is disposed on a first side of the support and the second pendulum-type mass is disposed on a second side of the support, and
at least one means for connecting the first and the second mass and pairing said masses, wherein the connecting means is disposed in a window of the support, one part of the contour of which defines the first rolling track, wherein
the connecting means extends between a first plane and a second plane, which are tangents to the connecting means,
the second rolling track is defined by the contour of the connecting means and extends from a third plane toward a fourth plane, which are secants to the connecting means,
a first distance measured between the first plane and the second plane is 1.5 to 3.5 times greater than a second distance measured between the third plane and the fourth plane, wherein the first plane, the second plane, the third plane and the fourth plane are parallel to one another.

2. A pendulum-type device according to claim 1, wherein the connecting means is provided with at least one system, for connection of the pendulum-type masses, that extends radially at least in part in the region of the second rolling track.

3. A pendulum-type device according to claim 2, wherein the connecting system comprises an assembly element received in an opening made in one circumferential end of the connecting means.

4. A pendulum-type device according to claim 3, wherein the opening is made by cutting, especially by stamping.

5. A pendulum-type device according to claim 1, comprising at least one abutting damping means interposed radially between the support and the connecting means.

6. A pendulum-type device according to claim 5, wherein the damping means has a substantially cubic shape, wherein the damping means is received in a recess made in the connecting means.

7. A pendulum-type device according to claim 2, wherein the connecting means is provided with two openings for receiving the assembly means circumferentially framing the second rolling track.

8. A pendulum-type device according to claim 1, wherein the pendulum-type member is configured to be tuned to an order value greater than or equal to 2, especially greater than 3, wherein it is greater than or equal to 3.3, and less than or equal to 4, and is less than 3.5.

9. A pendulum-type device according to claim 1, wherein it comprises several pendulum-type members, for example a number ranging between two and eight, wherein all of these pendulum-type members follow one another circumferentially, wherein each pendulum type member comprises two connecting means, wherein each connecting means is received in a window specific to it.

10. A pendulum-type device according to claim 9, wherein the distance between two adjacent windows may be chosen as a function of the shape of these said windows and of the shape of the pendulum-type masses, so that the angularly neighboring pendulum-type members never come into contact with one another.

11. A primary flywheel capable of being made integral with a crankshaft of a combustion engine of a vehicle, especially of an industrial vehicle, wherein the flywheel integrates a pendulum-type device according to claim 1.

12. A pendulum-type device according to claim 2, comprising at least one abutting damping means interposed radially between the support and the connecting means.

13. A pendulum-type device according to a claim 3, wherein the connecting means is provided with two openings for receiving the assembly means circumferentially framing the second rolling track.

14. A pendulum-type device according to claim 2, wherein the pendulum-type member is configured to be tuned to an order value greater than or equal to 2, especially greater than 3, wherein it is greater than or equal to 3.3, and less than or equal to 4, and is less than 3.5.

15. A pendulum-type device according to claim 2, wherein it comprises several pendulum-type members, for example a number ranging between two and eight, wherein all of these pendulum-type members follow one another circumferentially, wherein each pendulum type member comprises two connecting means, wherein each connecting means is received in a window specific to it.

16. A primary flywheel capable of being made integral with a crankshaft of a combustion engine of a vehicle, especially of an industrial vehicle, wherein the flywheel integrates a pendulum-type device according to claim 2.

17. A pendulum-type device according to claim 3, comprising at least one abutting damping means interposed radially between the support and the connecting means.

18. A pendulum-type device according to a claim 4, wherein the connecting means is provided with two openings for receiving the assembly means circumferentially framing the second rolling track.

19. A pendulum-type device according to claim 3, wherein the pendulum-type member is configured to be tuned to an order value greater than or equal to 2, especially greater than 3, wherein it is greater than or equal to 3.3, and less than or equal to 4, and is less than 3.5.

20. A pendulum-type device according to claim 3, wherein it comprises several pendulum-type members, for example a number ranging between two and eight, wherein all of these pendulum-type members follow one another circumferentially, wherein each pendulum type member comprises two connecting means, wherein each connecting means is received in a window specific to it.
